(19) United States
(12) Patent Application Publication
(10) Pub. No.: US 2014/0330705 A1
(43) Pub. Date: Nov. 6, 2014

(54) System and Method for Assembling Credit Data

(71) Applicant: Bank of America Corporation, Charlotte, NC (US)

(72) Inventors: James S. Wishart, Gilbert, AZ (US); Larry A. Parrott, Phoenix, AZ (US); John P. Phillips, Chandler, AZ (US); Dana M. Stillwell, Morganton, NC (US); Richard C. McKinnon, Garnet, PA (US); John A. Tsefrikas, Charlotte, NC (US)

(21) Appl. No.: 13/941,682

(22) Filed: Jul. 15, 2013

Related U.S. Application Data
(60) Provisional application No. 61/818,261, filed on May 1, 2013.

(51) Int. Cl. G06Q 40/02

(52) U.S. Cl. CPC G06Q 40/025
USPC 705/38

(57) ABSTRACT

An interface receives credit data from a plurality of data sources. The credit data comprises customer information. A processor determines a customer identifier associated with the credit data and links the customer identifier associated with the credit data to a customer identifier associated with historical credit data. The processor determines whether the customer information of the credit data is different from customer information of the historical credit data. When the customer information of the credit data is different than the customer information of the historical credit data, the processor updates the customer information of the credit data to match the customer information of the historical credit data. The interface communicates the updated credit data to a plurality of external modules with each external module associated with a credit bureau. The processor updates the historical credit data to include the updated credit data. The interface receives feedback from each external module, wherein the feedback comprises an external credit file report and rejected credit information from the communicated credit data and communicates the feedback from each external module to a data source.

### RELATED APPLICATIONS

This application claims priority to U.S. Provisional Patent Application Ser. No. 61/818,261, entitled “SYSTEM AND METHOD FOR ASSEMBLING CREDIT DATA,” which was filed on May 1, 2013. U.S. Provisional Patent Application Ser. No. 61/818,261 is hereby incorporated by reference.

### TECHNICAL FIELD

This invention relates generally to communicating and analyzing data, and more particularly to assembling credit data.

### BACKGROUND

Enterprises contain various business units. Each business unit reports information to external modules. In conventional systems, the different business units within an enterprise report information to external modules separately.

### SUMMARY OF EXAMPLE EMBODIMENTS

According to embodiments of the present disclosure, disadvantages and problems associated with assembling credit data may be reduced or eliminated.

In accordance with a particular embodiment of the present disclosure, an interface receives credit data from a plurality of data sources. The credit data comprises customer information. A processor determines a customer identifier associated with the credit data and links the customer identifier associated with the credit data to a customer identifier associated with historical credit data. The processor determines whether the customer information of the credit data is different from customer information of the historical credit data. When the customer information of the credit data is different than the customer information of the historical credit data, the processor updates the customer information of the credit data to match the customer information of the historical credit data. The interface communicates the updated credit data to a plurality of external modules with each external module associated with a credit bureau. The processor updates the historical credit data to include the updated credit data. The interface receives feedback from each external module, wherein the feedback comprises an external credit file report and rejected credit data from the communicated credit data and communicates the feedback from each external module to a data source.

Certain embodiments of the present disclosure may provide one or more technical advantages. A technical advantage of one embodiment includes reducing the number of transactions sent to the credit bureaus. As another example, a technical advantage of one embodiment includes mitigating an enterprise's responsibility in reporting inaccurate information. As yet another example, a technical advantage of one embodiment includes automatically detecting and correcting errors in credit data, providing a single and centralized reference for reported credit information logs, and improving the accuracy, consistency, and regularity of these communicated reports. As a final example, a technical advantage of one embodiment includes providing greater efficiencies for computer resources and network usage.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 illustrates a system for assembling credit data; and

FIG. 2 illustrates an example method for assembling the credit data.

### DETAILED DESCRIPTION

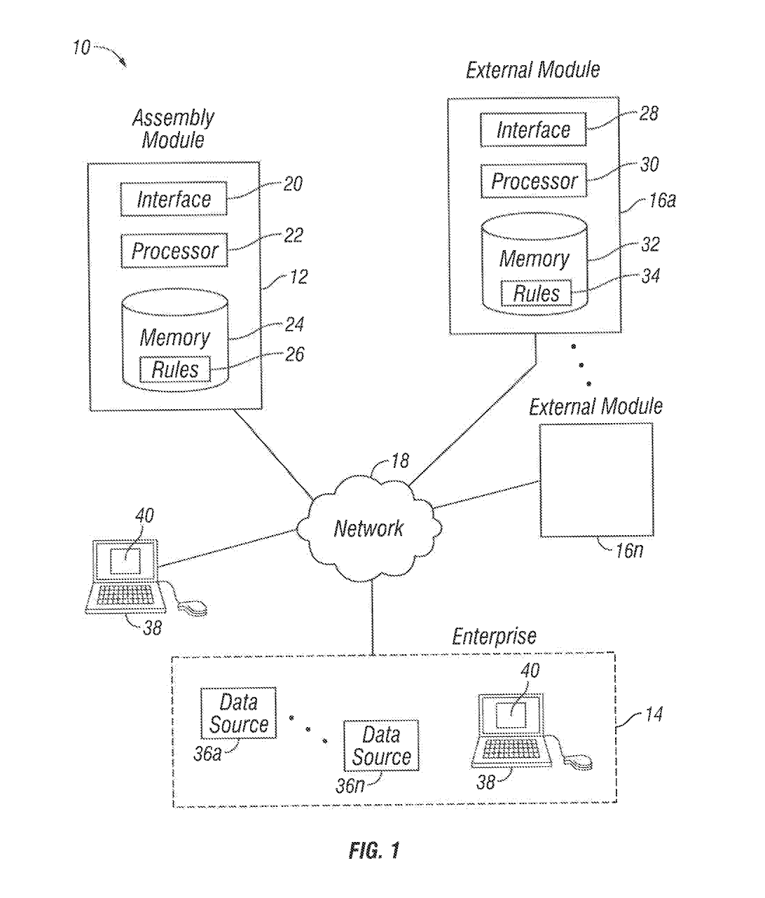

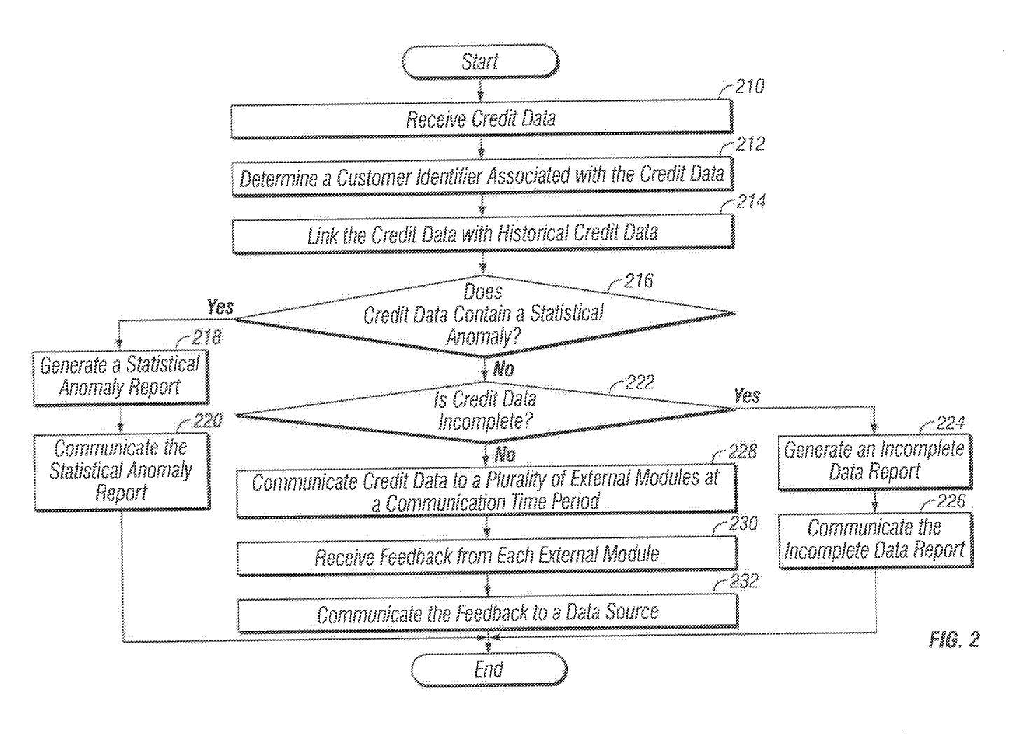

Embodiments of the present invention and its advantages are best understood by referring to FIGS. 1 and 2, like numerals being used for like and corresponding parts of the various drawings.

Enterprises typically include business units, divisions, or lines of businesses that handle various financial services within the enterprise. Financial services may include, but are not limited to, credit cards; lending such as mortgage loans, automobile loans, or business loans; commercial banking; and/or consumer banking.

To facilitate providing financial services, enterprises may report credit information to external vendors. Typically, each business unit reports credit data separately to a plurality of external vendors. The teachings of this disclosure recognize that it would be desirable to provide a module that receives credit data from a plurality of data sources, analyzes and manipulates the received credit data, and communicates the credit data to a plurality of external modules. The teachings of this disclosure also recognize that it would be desirable for the module to receive feedback from the plurality of external modules and communicate the feedback from each external module to a data source. Further, the teachings of this disclosure recognize that it would be desirable for the module to store and archive communicated credit data. This leads to greater efficiencies by reducing the number of transactions sent to credit bureaus, mitigating an enterprise's responsibility in reporting inaccurate information, automatically detecting and correcting errors in credit data, providing a single and centralized reference for reported credit information logs, and improving the accuracy, consistency, and regularity of communicated credit data. Additionally, the teachings of this disclosure provides for greater efficiencies in computer resources and network usage.

FIG. 1 illustrates a system for assembling credit data. More specifically, system 10 includes assembly module 12, enterprise 14, external modules 16a-16n, and computer 38 that may be communicatively coupled by network 18. Generally, assembly module 12, enterprise 14, external modules 16a-16n, and computer 38 interact to efficiently assemble, analyze, and communicate credit data.

System 10 includes assembly module 12, which may be located internal or external to enterprise 14. Assembly module 12 represents any suitable components that assembles received credit data from a plurality of data sources 36a-36n to external modules 16a-16n and the communication of feedback from external modules 16a-16n and communicates the assembled data. Additionally, assembly module 12 receives and assembles feedback from external modules 16a-16n and communicates the assembled feedback to enterprise 14. Assembly module 12 allows for an enterprise to have a single source of data collection and communication of credit data, which enables improved efficiencies in network usage and data collection. Assembly module 12, which may contain interface 20, processor 22, memory 24, and rules 26, may be communicatively coupled by network 18 to other components within system 10.

Assembly module 12 may include a network service, any suitable remote service, a mainframe, a host computer, a workstation, a web server, a personal computer, a file server, or any other suitable device operable to communicate with enterprise 14, external modules 16a-16n, and computers 38. In some embodiments, assembly module 12 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of assembly module 12 may be performed by any suitable combination of one or more servers or other components at one or more locations. In the embodiment where the modules are servers, the servers may be public or private servers, and each server may be a virtual or physical server. The server may include one or more servers at the same or at remote locations. Also, assembly module 12 may include any suitable component that functions as a server.

System 10 includes enterprise 14, which may refer to a financial institution, such as a bank. Enterprise 14 facilitates communicating information from data sources 36a-36n and computers 38 and receiving information from assembly module 12, external modules 36a-36n, and computers 38. In particular, enterprise 14 facilitates communicating credit data to assembly module 12 and receiving feedback from assembly module 12. Enterprise 14 may include data sources 36a-36n and computers 38. Even though enterprise 14 is referred to as a financial institution, enterprise 12 may include any suitable type of entity in any suitable industry.

System 10 includes external modules 16a-16n, where n represents any suitable number. External modules 16a-16n may be located external to enterprise 14. In the illustrated embodiment, external modules 16a-16n are associated with a credit bureau, such as Equifax®, Experian®, or Transunion®, or any vendor that reports credit information. Generally, external modules 16a-16n represent any suitable components that facilitate the receiving and processing of communicated credit data from assembly module 12 and the communicating of feedback to assembly module 12. Assembly module 12, which may contain interface 28, processor 30, memory 32, and rules 34, may be communicatively coupled by network 18.

External module 16 may include a network service, any suitable remote service, a mainframe, a host computer, a workstation, a web server, a personal computer, a file server, or any other suitable device operable to communicate with assembly module 12, enterprise 14, and computers 38. In some embodiments, external module 16 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of external module 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, external module 16 may include any suitable component that functions as a server.

Network 18 facilitates communications between assembly module 12, components in enterprise 14, external modules 16a-16n, and computers 38. This disclosure contemplates any suitable network 18 operable to facilitate communication between the components of system 10. Network 18 may include any interconnecting system capable of transmitting audio, video, signals, data, messages, or any combination of the preceding. Network 18 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of network 18.

In the illustrated embodiment, assembly module 12 includes interface 20, processor 22, and memory 24. Interface 20 represents any suitable device operable to receive information from network 18, transmit information through network 18, perform suitable processing of the information, communicate to other devices, or any combination of the preceding. For example, interface 20 transmits credit data to one or more external modules 16a-16n. As another example, interface 20 receives feedback from external modules 16a-16n and communicates the feedback to enterprise 14. Interface 20 represents any port or connection, real or virtual, including any suitable hardware and/or software, including protocol conversion and data processing capabilities, to communicate through a LAN, WAN, or other communication system that allows assembly module 12 to exchange information with network 18, external modules 16a-16n, enterprise 14, computers 38, and other components of system 10.

Processor 22 controls the operation and administration of assembly module 12 by processing information received from interface 20, and memory 24. Processor 22 communicatively couples to interface 20, and memory 24. Processor 22 includes any hardware and/or software that operates to control and process information. For example, processor 22 utilizes rules 26 to control the operation of assembly module 12. Processor 22 may be a programmable logic device, a microcontroller, a microprocessor, any suitable processing device, or any suitable combination of the preceding.

Memory 24 represents a database that stores, either permanently or temporarily, received credit data and historical credit data from assembly module 12. Memory 24 includes any one or a combination of volatile or non-volatile local or remote devices suitable for storing information. For example, memory 24 may include Random Access Memory (“RAM”), Read-only Memory (“ROM”), magnetic storage devices, optical storage devices, or any other suitable information storage device or a combination of these devices. Memory 24 may include any suitable information for use in the operation of assembly module 12. Additionally, memory 24 may be a component external to assembly module 12. Memory 24 can be located in assembly module 12, enterprise 14, or any other location suitable for memory 24 to communicate with assembly module 12.

Memory 24 includes rules 26. Rules 26 generally refer to logic, rules, algorithms, code, tables, and/or other suitable instructions embodied in a computer-readable storage medium for performing the described functions and operations of assembly module 12. For example, rules 26 facilitate the determination of whether a statistical anomaly exists in the received credit data. While illustrated as including a particular module, rules 26 may include any suitable information for use in the operation of assembly module 12.

In the illustrated embodiment, external module 16 includes interface 28, processor 30, and memory 32. Interface 28 represents any suitable device operable to receive information from network 18, transmit information through network 18, perform suitable processing of the information, communicate to other devices, or any combination of the preceding. For example, interface 28 receives credit data from assembly module 12. As another example, interface 28 transmits feedback to assembly module 12. Interface 28 represents any port or connection, real or virtual, including any suitable hardware and/or software, including protocol conversion and data processing capabilities, to communicate through a LAN, WAN, or other communication system that allows external module 16 to exchange information with network 18, assembly module 12, enterprise 14, computers 38, and other components of system 10.

Processor 30 controls the operation and administration of external module 16 by processing information received from interface 28, and memory 32. Processor 30 communicatively couples to interface 28, and memory 32. Processor 30 includes any hardware and/or software that operates to control and process information. For example, processor 30 utilizes rules 34 to control the operation of external module 16. Processor 30 may be a programmable logic device, a microcontroller, a microprocessor, any suitable processing device, or any suitable combination of the preceding.

Memory 32 represents a database that stores, either permanently or temporarily, received credit data and feedback from external module 16. Memory 32 includes any one or a combination of volatile or non-volatile local or remote devices suitable for storing information. For example, memory 32 may include RAM, ROM, magnetic storage devices, optical storage devices, or any other suitable information storage device or a combination of these devices. Memory 32 may include any suitable information for use in the operation of external module 16n. Additionally, memory 32 may be a component external to external module 16n. Memory 32 can be located in external module 16 or any other location suitable for memory 32 to communicate with external module 16.

Memory 32 also includes rules 34. Rules 34 generally refer to logic, rules, algorithms, code, tables, and/or other suitable instructions embodied in a computer-readable storage medium for performing the described functions and operations of external module 16n. For example, rules 34 facilitate the determination of whether to use a received credit data in generating a credit report. While illustrated as including a particular module, rules 34 may include any suitable information for use in the operation of external module 16.

Enterprise 14 includes data sources 36a-36n, where n represents any suitable number. Data sources 36a-36n may represent any source of information that may be used by assembly module 12 and/or components in enterprise 14. Data sources 36a-36n may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to assembly module 12), one or more documents (such as a newspaper that includes articles or other information about the entity), the Internet (which may include articles and other information about the entity), an open source intelligence report, a media outlet (such as a television station or a radio station that broadcasts information that may be communicated to assembly module 12), any other suitable source of information, or any combination of the preceding. In certain embodiments, assembly module 12 may receive information from data sources 36a-36n to communicate to external modules 16a-16n. Data sources 36a-36n may be located in enterprise 14 or any other location that allows for data source 36 to communicate via network 18.

Computers 38 may be any device that interacts with system 10. For example, computers 38 may interact with assembly module 12 to request credit data. Assembly module 12 may associate the requested customer identifier associated with the request to a customer identifier associated with a historical credit data and communicate the associated historical credit data to computers 38. Computers 38 may use a processor and a memory to execute an application in order to perform any of the functions described herein. Computers 38 may be a personal computer, a workstation, a laptop, a wireless or cellular telephone, an electronic notebook, a personal digital assistant, a tablet, or any other device (wireless, wireline, or otherwise) capable of receiving, processing, storing, and/or communicating information with other components of system 10. Computers 38 may also include a user interface, such as a display, a touchscreen, a microphone, keypad, or other appropriate terminal equipment usable by a user.

A component of system 10 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

To better understand the functions of system 10, an example of communicating credit data and receiving feedback will be used. However, it is understood that system 10 may be used in a variety of contexts and areas to help assembly module 12, enterprise 14, and external modules 16a-16n communicate data in an efficient matter, such as communicating credit data and receiving feedback.

In one exemplary embodiment of operation, assembly module 12 receives credit data from one or more data sources 36a-36n. Generally, credit data is reported on a particular customer for a financial issue, such as a high credit on an account, a past due amount, an opening or closing of an account, a bankruptcy filing, or an attempted settlement on an account. The credit data includes customer information and credit information. Customer information is information associated with the customer that does not readily change, such as a customer name, customer address, telephone number, social security number, or bank account number. Credit information may be credit information concerning one or more customers. The credit data may include information regarding a financial issue on one or more credit cards, mortgages, car loans, debts, or any other types of information that a credit bureau may use to compile a credit report. Assembly module 12 may receive credit data from multiple data sources 36. In certain embodiments, assembly module 12 may link the received credit data to each other according to the customer information or a customer identifier. Assembly module 12 may combine the credit data received from the multiple data sources 26 into one data stream. In particular embodiments, assembly module 12 accesses data sources 36a-36n to collect credit data.

In an embodiment, assembly module 12 associates the customer identifier in the credit data to a customer identifier in historical credit data. A customer identifier may be a social security number, bank account number, or any other identifier that identifies the customer from the list of customers of enterprise 14. Alternatively, assembly module 12 maps one or more customer identifiers in the credit data to a single customer identifier, such as a party identifier assigned by enterprise 14.

Historical credit data represents previously communicated credit data that assembly module 12 stores. Similar to credit data, historical credit data may include customer information and credit information. Assembly module 12 may link stored historical credit data to each other according to the customer information. Additionally, an entity may update assembly module 12 with updated information to store in historical credit data. For example, enterprise 14 may communicate updated customer information or credit information to assembly module 12 for assembly module 12 to update historical credit data. In certain embodiments, assembly module 12 may store only customer information in its historical credit data. Although historical credit data is described in the same format as credit data, assembly module 12 may manipulate, modify, transform, add, or delete historical credit data into other formats. Furthermore, historical credit data may store a certain time period of data (e.g., historical credit data may store only the past 365 days of communicated credit data).

Assembly module 12 may determine whether the customer information of the credit data is different from the customer information of the historical credit data. Assembly module 12 may update the customer information of the credit data to match the customer information of the historical credit data when a difference exists. For example, if received credit data contains a misspelling of a first name, assembly module 12 may determine that the first name is misspelled from comparing the misspelled name with the name indicated in the historical credit data. Assembly module 12 may then update the received credit data with the correctly spelled name from the historical credit data.

In certain embodiments, assembly module 12 determines whether the credit data is incomplete. Credit data may be incomplete if the credit data is missing required information. Required information may be any information required by one or more external modules 16 to process the incoming credit data. For example, required information may be a customer name, a customer address, social security number, bank account number, at least one credit information to report, or any other field that assembly module 12 determines is required for credit data. Required information may also include information required by enterprise 12 to include in reported credit data. If assembly module 12 determines that the credit data is missing required information, assembly module 12 will create and communicate an incomplete data report indicating the incomplete credit data. The incomplete data report may indicate the missing required information. In alternative embodiments, assembly module 12 may first attempt to fill in the missing required information from associated historical credit data before creating an incomplete data report.

Assembly module 12 may determine whether the received credit data contains a statistical anomaly. A statistical anomaly is particular information or group of information that falls outside of the normal range for that information or group of information. An example of a statistical anomaly is credit data that reports a high usage for a credit card for a particular date when the credit car was activated on a date subsequent to that particular date. Assembly module 12 may determine a statistical anomaly by analyzing historical credit data. For example, the statistical analysis on the credit data indicates that 50% of the reported credit data indicates a settled account in the past week, but the percentage of reported settled accounts is 10% based on the historical credit data. Assembly module 12 may consider this a statistical anomaly. If the received credit data contains a statistical anomaly, assembly module 12 will create and communicate a statistical anomaly report. The statistical anomaly report may indicate the statistical anomaly and the normal range for that information or group of information.

In a particular embodiment, assembly module 12 may also manipulate the credit data to form a METRO 2 credit format or any format acceptable for external modules 16a-16n. METRO 2 format represents the industry standard for reporting credit information. For example, some of the external modules 16a-16n may only receive credit data in METRO 2 format. In certain embodiments, assembly module 12 may manipulate the credit data for particular external modules 16.

Assembly module 12 may communicate the updated credit data to a plurality of external modules with each external module associated with a credit bureau. In some instances, assembly module 12 may not communicate the updated credit data if it contains a statistical anomaly or is incomplete. Assembly module 12 may communicate multiple credit data to external modules 16a-16n or may transmit credit data individually to the external modules 16a-16n. In certain embodiments, assembly module 12 may communicate the updated credit data to certain external modules 16a-16n. For example, assembly module 12 may determine external modules 16 to communicate credit data based on the type of credit data or the source of the received credit data. In certain embodiments, computers 38 may send an update request, the update request comprising a set of customer identifiers and particular external modules 16a-16n, to communicate credit data. Here, assembly module 12 will communicate historical credit data (or a variation of historical credit data such as the last reported credit data) associated with the customer identifier and communicate the credit data to the indicated external modules 16a-16n.

In particular embodiments, assembly module 12 determines a communication time period associated with each data source 36. For example, data source 36a requires that assembly module 12 communicate data source 36a's credit data daily while data source 36b requires that assembly module 12 communicate data source 36b's credit data weekly. In this example, assembly module 12 determines a communication time period associated with each data source 36 (e.g., daily for credit data received from data source 36a and weekly for credit data received data source 36b). Similarly, a communication time period may be associated with the type of credit data it is reporting (e.g., credit card data, mortgage data, business loan data, etc.). The communication time period indicates a time or periodicity to communicate the data. The communication time period can be a fixed time period, a variable time period, a time period that occurs when network resource usage is at a low period, or any indication of when assembly module 12 should communicate the updated credit data. Assembly module 12 will then communicate the updated credit data to external modules 16a-16n at the communication time period.

Assembly module 12 may also update the historical credit data to include the updated credit data. Assembly module 12 may update the historical credit data with portions of the updated credit data (e.g., credit information of the updated credit data). Assembly module 12 may update the historical credit data to include only a statistical representation of the historical credit data with the updated credit data. For example, assembly module 12 may update the average of the reported debt and the standard deviation of the reported debt for the historical credit data using the updated credit data and store the statistical representation in the historical credit data.

In the illustrated embodiment, external module 16 receives and processes the communicated credit data from assembly module 12. External module 16 may ensure the quality of the feedback, such as rejecting any credit data that is missing required information. Next, external module 16 may manipulate the accepted credit data and load the credit data into its database. Generally, external module 16 associates the accepted credit data with a customer inside its database, and loads the credit data onto that customer's credit history file. Therefore, when a party requests a credit history for a specific customer or group of customers, external module 16 may transmit a credit history report for the identified customer or group of customers.

Each external modules 16a-16n may communicate feedback to assembly module 12. The communicated feedback may include an external credit file report and rejected credit data from the communicated credit data. The external credit file report is a report that each external module 16 communicates after external module 16 receives the communicated credit data and generates credit data in its own system. Generally, external credit file report indicates which information of the communicated credit data external module 16 used to update or generate its credit report (e.g., credit data used for a particular customer's credit profile). For example, if external module 16 updates a customer's credit profile based on credit data, then the external credit file report will indicate the credit data that it used. The rejected credit data contains credit data that external module 16a-16n did not use to update its credit report. External module 16a-16n may not use credit data if it is missing required information, is inconsistent with previously reported credit data, or any other scenario where external module 16 may not use the entirety or part of communicated credit data.

Once received by assembly module 12, assembly module 12 communicates the feedback from each external module to one or more data sources 36a-36n. In certain embodiments, assembly module 12 associates the feedback with the communicated credit data and communicates the feedback to data source 36 that communicated the credit data.

In an exemplary embodiment, assembly module 12 may format the received feedback to a form usable by enterprise 14. For example, each external module 16 may communicate feedback in a different format. Assembly module 12 may manipulate each feedback into a standardized format before communicating the feedback to enterprise 14.

Assembly module 12 may also determine to update its manipulation of credit data or historical credit data from the received feedback. Assembly module 12 may determine from the feedback that a particular set of data continues to be rejected and, based on that determination, may update the manipulation of the credit data to prevent a similar rejection from occurring again. Assembly module 12 may extrapolate any type of corrections, additions, or deletions from the received feedback and update its manipulation of credit data or historical credit data. Similarly, assembly module 12 may add or delete credit data or historical credit data based on the feedback. In certain embodiments, assembly module 12 associates the rejected credit data from the feedback with the historical credit data and corrects historical credit data based on the rejected credit information.

In addition, assembly module 12 may receive a request for credit information from computer 38. The request for credit information may include a requested customer identifier, such as a bank account number, a social security number, or a last name. A requested customer identifier may also include a group of individuals, such as individuals that live in a certain location, have an income above a certain level, or contain a certain amount of savings. Assembly module 12 will determine customer identifiers from the request and then associate the requested customer identifier with historical credit data. Assembly module 12 will then communicate the historical credit data associated with the requested customer identifier to computer 38.

Modifications, additions, or omissions may be made to system 10 without departing from the scope of the invention. For example, system 10 may include any number of assembly modules 12, external modules 16a-16n, data sources 26a-26n, and computers 38. As another example, assembly module 12 may communicate a request for a credit data report from external module 16a-16n. Furthermore, the components of system 10 may be integrated or separated. For example, assembly module 12 and data source 26 may be incorporated into a single component.

FIG. 2 illustrates an example method for assembling the credit data. The method begins at step 210 when assembly module 12 receives credit data from data sources 36a-36n. At step 212, assembly module 12 determines a customer identifier associated with the credit data. At step 214, assembly module 12 links the credit data with historical credit data by matching the customer identifier of the credit data with the customer identifier of the historical credit data. A customer identifier may be a social security number, bank account number, or any other identifier that will identify the customer from the list of customers of enterprise 14. In certain embodiments, assembly module 12 uses a party identifier to link the customer identifier with the historical credit data. A party identifier is an identification based on one or more customer identifiers in the credit data.

At step 216, assembly module 12 determines if the credit data contains a statistical anomaly. A statistical anomaly is particular information or group of information that falls outside of the normal range for that information or group of information. Assembly module 12 may determine a statistical anomaly by analyzing historical credit data. If the received credit data contains a statistical anomaly, assembly module 12 will create a statistical anomaly report at step 218. The statistical anomaly report may indicate the statistical anomaly and the normal range for that information or group of information. At step 220, assembly module 12 communicates the statistical anomaly report to one or more components of enterprise 14, such as data source 36 or computers 38. If assembly module 12 determines that the credit data does not contain a statistical anomaly, then the method proceeds to step 222.

Assembly module 12 determines whether customer information of credit data is different from customer information of the historical credit data at step 222. Customer information is information associated with the customer that does not readily change, such as a customer name, customer address, telephone number, social security number, or bank account number. If the customer information of the credit data is different from the customer information of the historical credit data, assembly module 12 may update the customer information of the credit data to match the customer information of the historical credit data at step 224. For example, if received credit data contained a misspelling of a first name, assembly module 12 may determine that the first name is misspelled from comparing the misspelled name with the correctly spelled name in the historical credit data. Assembly module 12 would then update the received credit data with the correctly spelled name from the historical credit data and proceed to step 232. If assembly module 12 determines that the customer information of the credit data is the same as the customer information of the historical credit data, the method proceeds to step 226.

At step 226, assembly module 12 determines if the credit data is incomplete. Credit data may be incomplete if the credit data is missing required information. Required information may be any information required by one or more external modules 16a-16n to process the incoming credit data. Required information may also include information required by enterprise 12 to include in reported credit data. If assembly module 12 determines that the credit data is missing required information, assembly module 12 will generate an incomplete data report at step 228 and communicate the incomplete data report at step 230. If assembly module 12 determines that credit data is complete, the method proceeds to step 232.

Assembly module 12 communicates the credit data to a plurality of external modules 16a-16n at a communication time period at step 232. Assembly module 12 may communicate the plurality of credit data to external modules 16a-16n or may transmit credit data separately to external modules 16a-16n. In certain embodiments, assembly module 12 may communicate the updated credit data to certain external modules 16a-16n. The communication time period indicates a time or periodicity to communicate the data. The communication time period may vary the type of credit data. The communication time period can be a fixed time period, a variable time period, a time period that occurs when network resource usage is at a low period, or any indication of when assembly module 12 should communicate the updated credit data.

At step 234, assembly module 12 receives feedback from each external module 16a-16n. The feedback may include an external credit file report and rejected credit data from the communicated credit data. The external credit file report is a report that each external module 16 communicates after external module 16 receives the communicated credit data and stores credit data in its own system. Generally, external credit file report indicates which information of the communicated credit data external module 16a used to update or generate a credit report.

One or more external modules 16a-16n may communicate feedback to assembly module 12 at step 234. The external credit file report is a report that each external module 16 communicates after external module 16 receives the communicated credit data and generates credit data in its own system. Generally, external credit file report indicates which information of the communicated credit data external module 16 used to update its credit report. The rejected credit data contains credit data that external module 16 did not use to update its credit report. Once received by assembly module 12, assembly module 12 communicates the feedback from each external module 16 to one or more data sources 36a-36n at step 236. In certain embodiments, assembly module 12 associates the feedback with the communicated credit data and communicates the feedback to data source 26 that communicated the credit data.

Modifications, additions, or omissions may be made to the method depicted in FIG. 2. The method may include more, fewer, or other steps. For example, assembly module 12 may determine whether the credit data is complete but not determine whether the credit data contains a statistical anomaly. As another example, assembly module 12 may attempt to correct incomplete credit data and communicate the corrected credit data to external modules 16a-16n. As yet another example, steps may be performed in parallel or in any suitable order. While discussed as assembly module 12 performing the steps, any suitable component of system 10 may perform one or more steps of the method.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system, comprising:
an interface operable to receive credit data from a plurality of data sources, the credit data comprising customer information;
a processor communicatively coupled to the interface and operable to:
determine a customer identifier associated with the credit data;
link the customer identifier associated with the credit data to a customer identifier associated with historical credit data;
determine whether the customer information of the credit data is different from customer information of the historical credit data;
when the customer information of the credit data is different than the customer information of the historical credit data, update the customer information of the credit data to match the customer information of the historical credit data;
the interface is further operable to communicate the updated credit data to a plurality of external modules, each external module associated with a credit bureau;
the processor is further operable to update the historical credit data to include the updated credit data; and
the interface is further operable to:
receive feedback from each external module, wherein the feedback comprises an external credit file report and rejected credit data from the communicated credit data; and
communicate the feedback from each external module to a data source.

2. The system of claim 1, wherein:
the processor is further operable to:
determine whether the credit data is incomplete, wherein the credit data is incomplete if the credit data is missing required information, and in response to the credit data being incomplete, generate an incomplete data report indicating the incomplete credit data; and
the interface is further operable to communicate the incomplete data report.

3. The system of claim 1, wherein:
the processor is further operable to:
determine whether the credit data contains a statistical anomaly, and in response to the credit data containing the statistical anomaly, generate a statistical anomaly report indicating the statistical anomaly; and
the interface is further operable to communicate the statistical anomaly report.

4. The system of claim 1, wherein:
the interface is further operable to:
receive a request for credit data from a computer, the request comprising a requested customer identifier; and
communicate historical credit data associated with the requested customer identifier to the computer; and
the processor is further operable to associate the requested customer identifier to a customer identifier associated with the historical credit data.

5. The system of claim 1, wherein communicating, by the interface, the updated credit data to a plurality of external modules further comprises:
the processor is further operable to determine a communication time period associated with each data source, wherein the communication time period indicates a time to communicate the credit data; and
the interface is further operable to communicate the updated credit data to a plurality of external modules at the communication time period.

6. The system of claim 1, wherein the processor is further operable to manipulate the credit data to a METRO 2 format.

7. Non-transitory computer readable medium comprising logic, the logic, when executed by a processor, operable to:
receive credit data from a plurality of data sources, the credit data comprising customer information;
determine a customer identifier associated with the credit data;
link the customer identifier associated with the credit data to a customer identifier associated with historical credit data;
determine whether the customer information of the credit data is different from customer information of the historical credit data;
when the customer information of the credit data is different than the customer information of the historical credit data, update the customer information of the credit data to match the customer information of the historical credit data;
communicate the updated credit data to a plurality of external modules, each external module associated with a credit bureau;
update the historical credit data to include the updated credit data;
receive feedback from each external module, wherein the feedback comprises an external credit file report and rejected credit data from the communicated credit data; and
communicate the feedback from each external module to a data source.

8. The computer readable medium of claim 7, wherein the logic is further operable to:
determine whether the credit data is incomplete, wherein the credit data is incomplete if the credit data is missing required information, and in response to the credit data being incomplete:
generate an incomplete data report indicating the incomplete credit data; and
communicate the incomplete data report.

9. The computer readable medium of claim 7, wherein the logic is further operable to:
determine whether the credit data contains a statistical anomaly, and in response to the credit data containing the statistical anomaly:
generate a statistical anomaly report indicating the statistical anomaly; and
communicate the statistical anomaly report.

10. The computer readable medium of claim 7, wherein the logic is further operable to:
receive a request for credit data from a computer, the request comprising a requested customer identifier;
associate the requested customer identifier to a customer identifier associated with the historical credit data; and
communicate historical credit data associated with the requested customer identifier to the computer.

11. The computer readable medium of claim 7, wherein the logic operable to communicate the updated credit data to a plurality of external modules is further operable to:
determine a communication time period associated with each data source, wherein the communication time period indicates a time to communicate the credit data; and
communicate the updated credit data to a plurality of external modules at the communication time period.

12. The computer readable medium of claim 7, wherein the logic is further operable to manipulate the credit data to a METRO 2 format.

13. A method, comprising:
receiving, by an interface, credit data from a plurality of data sources, the credit data comprising customer information;
determining, by a processor, a customer identifier associated with the credit data;
linking, by the processor, the customer identifier associated with the credit data to a customer identifier associated with historical credit data;
determining, by the processor, whether the customer information of the credit data is different from customer information of the historical credit data;
when the customer information of the credit data is different than the customer information of the historical credit data, updating, by the processor, the customer information of the credit data to match the customer information of the historical credit data;
communicating, by the interface, the updated credit data to a plurality of external modules, each external module associated with a credit bureau;
updating, by the processor, the historical credit data to include the updated credit data;
receiving, by the interface, feedback from each external module, wherein the feedback comprises an external credit file report and rejected credit data from the communicated credit data; and
communicating, by the interface, the feedback from each external module to a data source.

14. The method of claim 13, further comprising:
determining, by the processor, whether the credit data is incomplete, wherein the credit data is incomplete if the credit data is missing required information, and in response to the credit data being incomplete:
generating, by the processor, an incomplete data report indicating the incomplete credit data; and
communicating, by the interface, the incomplete data report.

15. The method of claim 13, further comprising:
determining, by the processor, whether the credit data contains a statistical anomaly, and in response to the credit data containing the statistical anomaly:
generating, by the processor, a statistical anomaly report indicating the statistical anomaly; and
communicating, by the interface, the statistical anomaly report.

16. The method of claim 13, further comprising:
receiving, by the interface, a request for credit data from a computer, the request comprising a requested customer identifier;
associating, by the processor, the requested customer identifier to a customer identifier associated with the historical credit data; and
communicating, by the interface, historical credit data associated with the requested customer identifier to the computer.

17. The method of claim 13, wherein communicating, by the interface, the updated credit data to a plurality of external modules further comprises:
determining, by the processor, a communication time period associated with each data source, wherein the communication time period indicates a time to communicate the credit data; and
communicating, by the interface, the updated credit data to a plurality of external modules at the communication time period.

18. The method of claim 13, further comprising manipulating, by the processor, the credit data to a METRO 2 format.
